(19) United States
(12) Patent Application Publication
(10) Pub. No.: US 2012/0162401 A1
(43) Pub. Date: Jun. 28, 2012

(54) IMAGING SYSTEM

(75) Inventors: Patrick C. MELDER, Marietta, GA (US); David S. GUY, Canton, GA (US)

(73) Assignee: Envisionier Medical Technologies, Inc., Woodstock, GA (US)

(21) Appl. No.: 13/277,597

(22) Filed: Oct. 20, 2011

Related U.S. Application Data
(63) Continuation-in-part of application No. PCT/US2010/031696, filed on Apr. 20, 2010.
(60) Provisional application No. 61/496,566, filed on Jun. 14, 2011.
(60) Provisional application No. 61/533,391, filed on Sep. 12, 2011.
(60) Provisional application No. 61/170,863, filed on Apr. 20, 2009.

(51) Int. Cl. H04N 7/18

(52) U.S. Cl. 348/65; 348/E07.085

(57) ABSTRACT

A unified imaging platform is disclosed. The unified imaging platform can be adapted for use with a variety of medical imaging devices. The unified medical imaging platform can include a display, a processor, a data storage device and one or more external interfaces. The unified imaging platform can be removably coupled to a medical imaging device such as an endoscope. The unified imaging platform can be coupled to the medical imaging device via a wired or wireless link. Using web services, the unified imaging platform can also transfer image data to other devices including a local desktop computer system, a mobile device and/or a remote system. Also disclosed is a medical imaging system including a router module wirelessly transmitting image data to a tablet PC or other distinct display device. The tablet PC may communicate corresponding image data to another tablet PC via a wireless telephone network.

### CROSS-REFERENCE TO RELATED APPLICATIONS

This application is a continuation-in-part of International Application No. PCMS10/31696, filed Apr. 20, 2010, which claims the benefit of U.S. Provisional Application No. 61/170,863, filed Apr. 20, 2009, and this application claims the benefit of priority under 35 U.S.C. 119(e) to U.S. Provisional Patent Application No. 61/496,566, filed Jun. 14, 2011, and U.S. Provisional Patent Application No. 61/533,391, filed Sep. 12, 2011, the entire disclosures of each of said applications being hereby incorporated herein by reference in their entireties.

### FIELD OF THE INVENTION

The present invention relates generally to portable imaging systems, and more particularly to an endoscopic imaging system having a flexible tube with a distal image sensor configured to communicate captured still and/or video images to a display, e.g. by wireless data transmission.

### BACKGROUND

Various technologies are available to the medical profession for use in viewing and imaging internal organs and systems of the human body. For example, a bronchoscope can be used by way of the nose, mouth or tracheostomy to visualize the inside of the airways; laryngoscopes can be used for intubation, to detect causes of voice problems, to detects causes of throat and ear pain, to evaluates difficulty in swallowing, and to detect strictures or injury to the throat, or obstructive masses in the airway; a gastroscope can be used to diagnose the cause of unexplained anemia, upper gastrointestinal bleeding, persistent dyspepsia, heartburn and chronic acid reflux, persistent vomiting, dysphagia, and odynophagia. A gastroscope can also be used to monitor Barrett's esophagus, gastric ulcer or duodenal ulcer, and post healing gastric surgery.

As a further example, otolaryngologists often require an endoscopic examination of the patient's upper respiratory system. One of the most common tools used by otolaryngologists to view the upper respiratory system is an endoscope. Similarly, endoscopes are used by surgeons and physicians in many fields of medicine, such as in pulmonary, and urology, in order to view parts of the human body internally for examination, diagnosis, and treatment. Endoscopes are also used in the gastrointestinal tract. Traditionally, the endoscope was an optical instrument. The endoscope can have a rigid or flexible tube and provide an image for visual inspection and photography. The rigid endoscope, while originally hollow, typically includes a series of glass rods at intermittent distances from each other sheathed in a tube, with an accompanying fiber-optic light bundle to direct a light upon the object under examination. The flexible endoscope replaces the series of glass rods with tiny fiber-optic glass rods which simply transmit an image from the distal tip to an eye piece.

In addition, certain flexible endoscopes replace the series of optical glass rods sheathed in a tube, with a solid state camera located at the distal end of the flexible endoscopic tube. The solid state camera can be a self-scanning solid state imaging device such as a charge coupled device (CCD) or a complementary metal-oxide semi-conductor (CMOS) sensor. An objective or image forming lens can be provided in front of the solid state camera. The lens is arranged to focus an image upon the CCD. A pre-amplifier is coupled to the output of the CCD. A line carrying the signal from the pre-amplifier extends through the flexible tube to the proximal end of the endoscope for coupling to a remote image processor. Color image sensors typically utilize one of various means of determining color, such as a color filter array.

An external light source is typically provided to illuminate the organ or object under inspection. The light source typically provides light directed via the optical fiber system extending through the tube or through a portable light source attached at a light guide of an endoscope.

The endoscope can also enable taking biopsies and retrieval of foreign objects. The tube can provide for an additional channel to allow entry of medical instruments or manipulators.

Initially, endoscopes included only an eyepiece, through which the physician could view the area being examined and/or treated. Later systems included video adapters to couple a camera head to the eyepiece. The camera head coupled the eyepiece to a video system. The video system was coupled to a monitor. Thus, the image as viewed from the eyepiece could now be more easily seen on the monitor. If the user wishes to capture, store, store, and edit the images and/or video, then additional equipment must be acquired such as a tape recorder, optical media device, and a printer. All of this equipment is typically stored on a cart. The cart typically includes wheels for mobility and is coupled to the endoscope via the various cables.

The camera control unit and accompanying computer and viewing screen are bulky, heavy, and not easily transported to different locations. In addition to the size and transport limitations, the systems currently available can range in cost from $ 10,000 or more for just the camera and camera control unit. In addition to the cost of the camera and camera control unit, the endoscope, and typically a light source, display monitor and recording medium must be purchased.

Manufacturers have attempted to produce digital archiving platforms to allow easy integration into the digital age by integrating disc burners and hard drives into the endoscopy units so that exams can be stored directly onto removable media. These alternatives, however, limit editing of the images and are not very dynamic. Other manufacturers have attempted to produce endoscopy units that capture the images directly into a proprietary computer system designed for the specific function of video capturing and archiving. These systems provide better data manipulation, but can cost more than $ 20,000, and thus not affordable for a small or cost-limited practice.

Some alternative systems have been designed with portable components. These portable component systems are smaller in size than the fixed systems, but still require a camera control unit, a monitor, a means for capturing the images, and a light source in addition to the main components of a camera and endoscope. Although these systems are classified as portable, they are heavy, cumbersome, and expensive. U.S. Pat. No. 6,432,046 issued to Yarush et al and discloses a hand-held portable camera for producing video images of an object, and has as an object to provide a camera which features a lighting system capable of high-intensity illumination without creating an over abundance of heat. Yarush et al discloses a fixed lens tube which receives a variety of apparently custom probes and, in certain embodiments, further requires one of several adapters to receive certain probes. Additionally, this aforementioned patent is not readily adapted to the standard fittings of the eyepiece of endoscopes used in medical practices.

U.S. Patent Publication No. 2007/0276183 discloses a portable battery operated hand-held endoscopy system adapted for interchangeable use with a variety of endoscopes, and is incorporated herein by reference. The endoscopy system includes a portable battery operated hand-held camera unit having a liquid crystal display (LCD). The camera unit couples to the eyepiece of an endoscope. A typically external light source couples to the endoscope.

It is desired to further improve the portability, versatility and ergonomic use of such portable, hand-held endoscopic imaging systems, and more particularly to an endoscopic imaging system having a flexible tube with a distal image sensor.

### SUMMARY

The present invention merges data acquisition with storage and management in a novel way, including using web application allowing practitioner to patient sharing, synchronization of patient folders, and sending an image or video by a secured connection to a referring practitioner, anytime, anywhere.

There has thus been outlined, rather broadly, the more important features of the invention in order that the detailed description thereof that follows may be better understood, and in order that the present contribution to the art may be better appreciated. There are, of course, additional features of the invention that will be described further hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that equivalent constructions insofar as they do not depart from the spirit and scope of the present invention, are included in the present invention.

For a better understanding of the invention, its operating advantages and the specific objects attained by its uses, reference should be had to the accompanying drawings and descriptive matter which illustrate preferred embodiments of the invention.

### BRIEF DESCRIPTION OF THE DRAWINGS AND THE FIGURES

FIG. 1 is a perspective view of a prior art endoscope having a flexible insertion tube and tubing for the light source and suction;

FIG. 2 is a perspective view of one embodiment of an endoscopic imaging system having a flexible insertion tube, with a distal image sensor and a proximal image processor, in accordance with the present disclosure;

FIG. 3 is a perspective view of another embodiment of an endoscopic imaging system having a flexible insertion tube, with a distal image sensor, and a removable proximal image processor and display, in accordance with the present disclosure;

FIG. 4 is a diagram showing an exemplary medical imaging system;

FIG. 5 is a block diagram of an exemplary unified imaging platform according to the disclosure;

FIG. 6 is a block diagram of an exemplary endoscopic system having a rigid or flexible image collection end and a proximate image sensor;

FIG. 7 is a block diagram of an exemplary endoscopic system having a distal image sensor and an electrically coupled display unit;

FIG. 8 is a block diagram of an exemplary system having a distal image sensor and wirelessly coupled display unit;

FIG. 9 is a block diagram of a display unit coupled to an endoscopic imaging cart system;

FIG. 10 is a block diagram of a display unit coupled with a docking station;

FIG. 11 is a block diagram of a software system architecture in accordance with the present disclosure;

FIG. 12 is a block diagram showing integration between an exemplary imaging system in accordance with the present disclosure and a healthcare information system;

FIG. 13 is an exemplary screenshot of a remote image system web application user interface;

FIG. 14 is a flowchart showing an exemplary workflow using an imaging system in accordance with the present disclosure;

FIG. 15 illustrates an exemplary HD camera medical imaging system in accordance with the present disclosure; and

FIG. 16 is a diagram showing an exemplary alternative medical imaging system.

### DETAILED DESCRIPTION

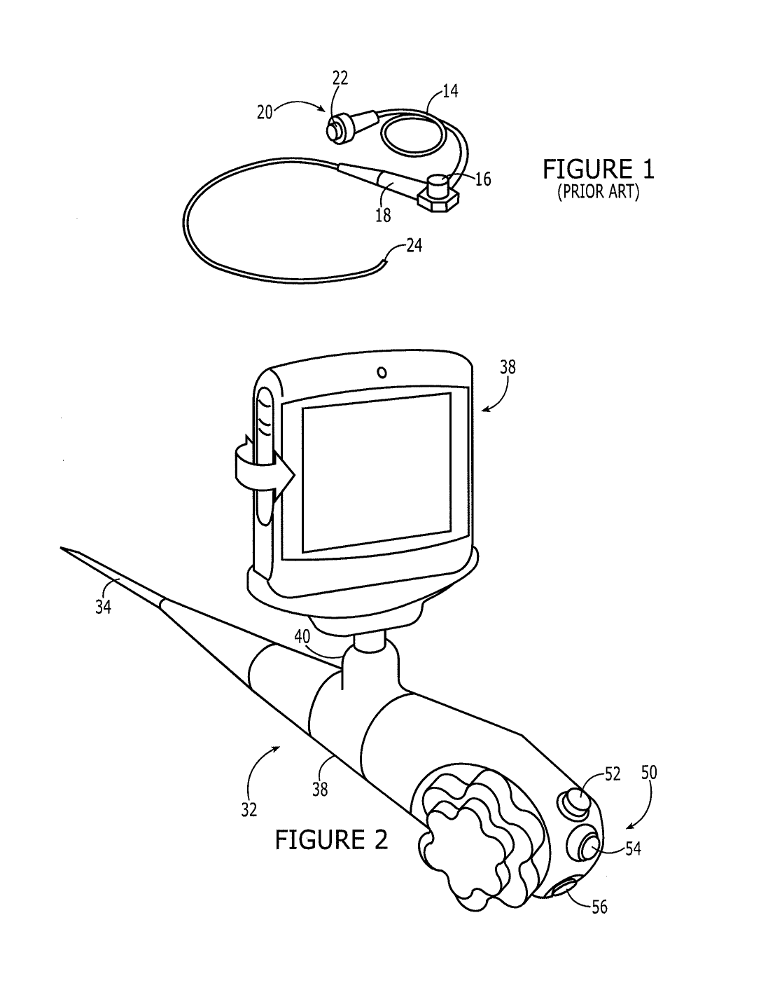

A prior art endoscope 10 is shown in FIG. 1. The endoscope 10 is shown to include a flexible insertion tube 12 and tubing 14 which conveys light from a light source and suction to the insertion tube 12. The endoscope 10 includes two stacked wheels 16 to provide four basic degrees of movement, e.g., up/down and left/right, of the insertion tube 12, such as used in pulmonary endoscopes and gastroscopes. Endoscopes having flexible insertion tubes and being designed for use in otolaryngology, urology, and gynecology typically have a single wheel or lever to provide two degrees of movement, e.g., up and down. An additional channel 18 is provided for entry of medical instruments or manipulators. A connector 20 is provided at the end of the tubing 14. The connector 20 is adapted for connection to a remote light source (not shown) and suction source (not shown), and further includes a connection 22 for coupling to a remote video system (not shown). A distal image sensor 24 and related components are located at the distal tip of the flexible insertion tube 12. A wire or line (not shown) extends from the distal image sensor 24 through the length of the flexible insertion tube 12 and continues through the tubing 14 to the connector 20.

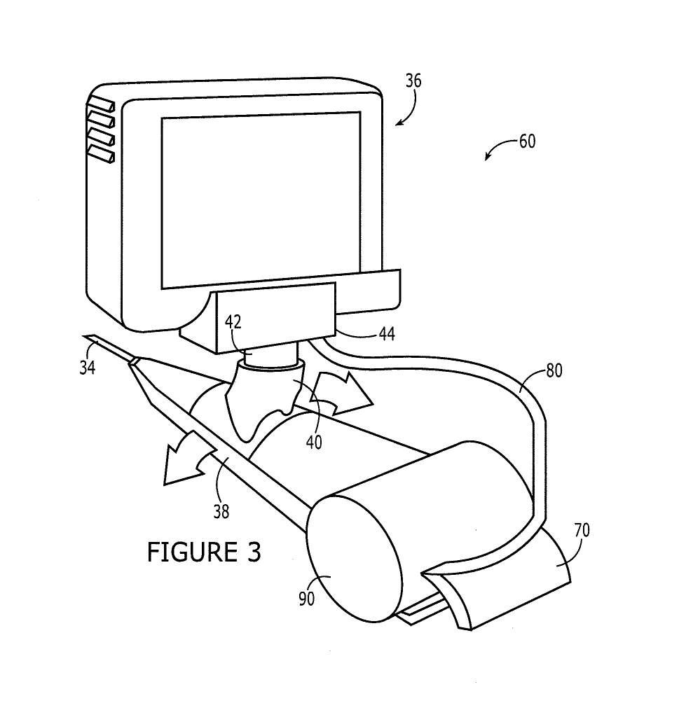

FIG. 2 is a perspective view of one embodiment of an endoscopic imaging system 30 in accordance with the present invention. The endoscopic imaging system 30 includes an endoscope 32 having a flexible insertion tube 34, with a distal image sensor 24 and related components (not shown in FIG. 2) located at the distal end of the insertion tube 34. A wire or line (not shown) extends from the distal image sensor 24 through the length of the flexible insertion tube 12 to the proximal end of the endoscope 32.

A viewing screen or video display unit 36 is shown coupled to the endoscope 32. The video display unit 36 may include a video display such as a liquid crystal display (LCD), light emitting diode (LED) display, plasma display or the like, for example. The endoscope 32 is shown to include a rotating ring 38 which rotates about the longitudinal axis of the endoscope 32. The rotation ring 38 includes a neck portion 40. The video display unit 36 is shown to include a stem portion 42 rotatably coupled to the neck portion 40 of the rotating ring 38. Thus, the video display unit 36 is movable with the rotation of the rotating ring 38 about the longitudinal axis of the endoscope 32, as well as pivotal about the longitudinal axis of the stem portion 42.

In one embodiment, as shown in FIG. 2, the video display unit 36 is removable. In particular, FIG. 2 shows that video display unit 36 is removable from the endoscope 32. A display holder 44 is coupled to the stem portion 42. The holder 44, similar to the video display unit 64, is thus capable of the same axial rotation about the stem portion 42 as well as the rotation about the axis of the endoscope 32. The display holder 44 is adapted to receive the removable video display 36. In one embodiment, the removable video display unit 36 is coupled to the electronics of the endoscope 32 via a connector (not shown) located at the bottom of the video display unit 36 and a mating connector (not shown) located within the interior cavity formed by the holder 44. It is also anticipated that the video display unit 36 may include a wireless interface for wireless communication with a corresponding wireless interface coupled to the electronics in the endoscope 32.

In one embodiment, the video display unit 36 includes an analog-to-digital (A/D) converter having an input coupled to the connector of the video display unit 36. An output of the A/D converter is coupled to an image processor also located in the video display unit 36. The video display unit 36 further includes a controller coupled to the image processor and to the connector of the video display unit 36. The video display unit further includes various memory and various external interfaces coupled to the image processor and controller. Thus, in relation to the endoscope 32, the image processor is proximally located.

The endoscope 32 includes two stacked wheels 16 to provide four basic degrees of movement, e.g., up/down and left/right, of the flexible insertion tube 34. The endoscope 32 further includes a plurality of user input control switches or buttons 50. The switches or buttons 50 are connected to the connector of the endoscope 32, or display holder 44 or in the case of a removable video display unit 36. Thus, the switches or buttons 50 may be connected to the internal components of the video display unit 36. The plurality of user input control switches or buttons 50 include direction button 52, mode button 54, and menu button 54. Direction button 52 is preferably a digital joystick, normally spring biased to remain in a central, vertical orientation, which may be momentarily rocked into forward, reverse, left and right orientations, relative to its central orientation. One of the functions of direction button 53 is to select a digital zoom level for image viewing and capture. Movement of direction button to the forward or reverse orientation causes an associated positive or negative change in the digital zoom level of the image to be viewed and the still or motion video image to be captured. In a preferred embodiment, a zoom level of up to 4× digital magnification may be selected using direction button 52. Mode button 54 and menu button 56 are preferably pushbutton, momentary switches.

Direction button 52 performs several additional functions, in conjunction with mode button 54, menu button 56, and an on-screen menu presented to the physician using video display unit 36, under control of the microprocessor, or digital signal processor, contained within the endoscope 32. In particular, using these three buttons, the physician can play back video clips and select from amongst still images for viewing, view an index of “thumbnail” images of such recordings and still images, fast forward, fast reverse, and stop playing video clips, select a video/still capture image resolution mode of 1, 3 or 6 mega-pixels, record audio voice clips, turn image date stamping on and off, enable and disable automatic image stabilization, adjust the white balance setting of captured images, turn image histogram displays on and off, choose from amongst natural color, black and white, and sepia toned image capture, manually adjust the image exposure level, activate a 10-second electronic shutter self-timer, enable/disable on screen display icons, select the video output resolution (i.e., 640×480 or 320×240 pixels), and combine two images taken individually into one image.

Moreover, the on-screen menu can also be employed to delete images and video clips, view a “slide show” of previously captured images, and to print images directly to an attached, PICTBRIDGE®-compatible printer. In addition, the on-screen menu can be used to set an internal date and time, enable/disable audio beep sounds, set the display flicker frequency to 50 Hz or 60 Hz, set the direct, analog TV output of the high speed I/O data port to either NTSC or PAL video formats, set the brightness of video display unit 36, format the internal and removable storage media; turn automatic shutoff on and off, set the language for the on screen display, and set a mode of operation of the USB port (depending upon the setting, when connected to a personal computer via the high speed USB port, the on screen display will either display a menu permitting the physician to select a desired connection mode, will automatically connect in “removable disk” mode, or will automatically enter printer mode). The menu may also allow for pixel calibration, creation of a new patient profile, calibration of a touchscreen interface, and/or control of the backlight of a display monitor.

A high speed I/O data transfer port (not shown) on the video display unit 36 permits both digital data transfers to an external computer, such as a personal desktop or laptop computer, via a conventional Universal Serial Bus (USB) interface, as well as analog video output to a conventional video display monitor, via an appropriate accessory AV cable. Data transfer port, when coupled to a PICTBRIDGE®-compatible USB printer, permits still images captured by the endoscopic camera to be printed directly, without the need for an intermediate external computer. A power-on switch (not shown) is disposed on the endoscope 32.

A snap fit battery door (not shown), removable with the aid of a plurality of gripping ribs, permit access to a portion of the interior of endoscope 32, to permit removal and replacement of a rechargeable battery powering the endoscope 32, as well as the insertion and removal of a flash memory card storing captured motion video and/or still images.

A functional block diagram (not shown) of one embodiment of the present invention, includes an endoscope 32 having an image acquisition device which may be a CCD chip 110, for example. The image acquisition device is connected to the input of a pre-amplifier which provides an output coupled to an electrical line extending through the flexible insertion tube 34 and to the connector card at the holder 44. The endoscope 32 further includes the fiber light source extending through the flexible insertion tube 34 and to the connector 20. The plurality of user input control switches or buttons 50 each have a circuit which extends to a connector card at the holder 44. The video display unit 36 includes an analog-to-digital converter coupled to the connector of the video display unit 36. The image processor is coupled to the A/D converter. The image processor is also coupled to the controller, various memory, and various optional external interfaces. The controller is also coupled to various memory and optional external interfaces, as well as the user input control switches or buttons 50.

The optional external interfaces can include a high speed data transfer port 142, an analog output, such as audio S for coupling to an external device, and removable flash memory. On board flash memory can also be provided in the display unit 36.

Additional internal components of the endoscopic system include a battery, removable flash memory card, primary printed circuit board, secondary printed circuit boards. The battery is preferably a conventional lithium-ion type battery, which can be removed for recharging in a separate charging unit by first removing battery door from the main body portion or proximal end of the endoscope 32. Alternatively, or in addition, a battery recharging jack can be disposed on the main body portion, and a suitable recharging cradle or stand supplied, to permit the battery to be recharged in situ.

Removable flash memory card preferably comprises an industry standard Secure Digital (SD) card, Mini SD card with SD card adapter, or MultiMedia card (MMC). Memory card is releasable and is retained within an associated card slot, and can be removed from within the camera housing upon removal of the battery door.

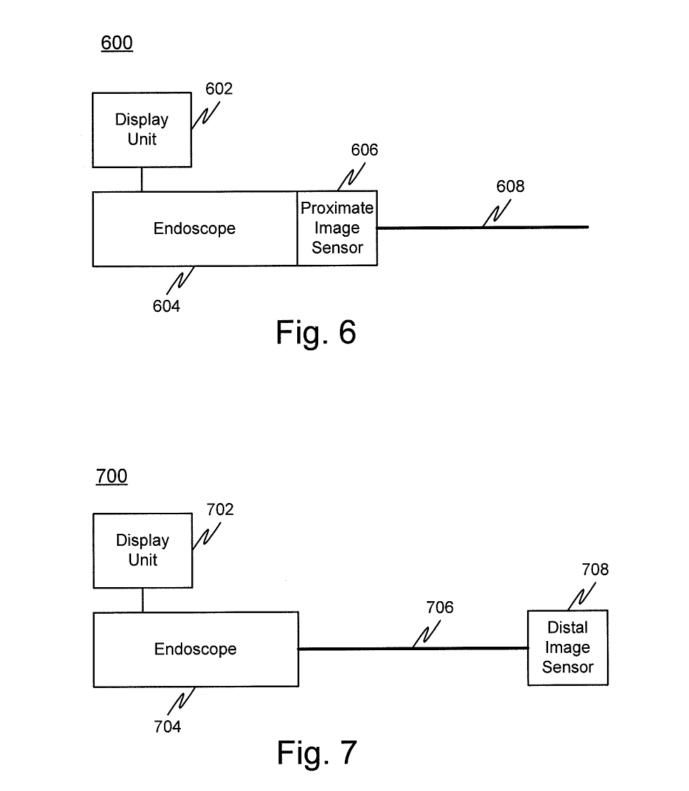

Primary printed circuit board can include much of the circuitry, including A/D converter, digital signal processor or microprocessor, controller, and on-board flash memory. Secondary printed circuit board may carry direction button, mode button, and menu button. Secondary printed circuit board may carry redundant video record button and redundant still photograph shutter button. An additional sensor board maybe located proximally to the optics of the device for encoding the captured image for processing. Further discussion of the sensor board is provided below with reference to FIGS. 6, 7 and 8. The sensor board may be configured as a daughterboard to the primary printed circuit board.

Main body portion may further contain a miniature microphone (not shown), also coupled to primary printed circuit board. In conjunction with on-screen menu functions provided via display and processor, the microphone permits the physician to record sound clips, such as voice annotations, to the internal flash memory storage or the removable flash memory card, and to transfer such sound/voice clips to an external personal computer.

In another embodiment, the majority of the electronics reside in the main body portion or proximal end of the endoscope 32. For example, the A/D converter, image processor and controller are located in the main body portion and are coupled to the video display unit 36.

FIG. 3 shows another embodiment of the endoscopic system of the present invention. FIG. 3 shows an endoscopic imaging system 60 which includes an endoscope 32 having a flexible insertion tube 34, with a distal image sensor 24 and related components (not shown in FIG. 3) located at the distal end of the insertion tube 34. A wire or line (not shown) extends from the distal image sensor 24 through the length of the flexible insertion tube 12 to the proximal end or main body portion of the endoscope 32. A removable viewing screen or video display unit 36 is shown coupled to the endoscope 32. The system 60 of FIG. 3 is very similar to the system 30 of FIG. 2, with the exception that the majority of the electronics are located outside of the main body portion or proximal end of the endoscope 32. For example, as described in connection with FIG. 2, the majority of the electronic components are located in the removable video display unit 36. A cord 80 extends from the removable video display unit 46 to a removable adaptor 70. The removable adaptor 70 may include the user switches or buttons 50. The adaptor 70 is removably attachable to the endoscope 32, together with the cord 80 and removable video unit 36 to accommodate cleaning of the endoscope 32.

Alternatively, the majority of the electronics reside in the adaptor 70. For example, the A/D converter, image processor and controller are located in the adaptor 70 and are coupled to the video display unit 36 via the cord 80.

The two axis control 90 provides control of the distal end of the flexible insertion tube 34 as is known in the art.

Transmission software and related applications are further contemplated to be used in conjunction with the present invention as discussed hereinbelow.

In one video display unit embodiment, video compression in DV quality is performed using MPEG-4 video compression. Stills are compressed using a JPEG compression algorithm: both are industry standard methods for data compression. After use, images can be transported from the removable flash RAM drive (SD RAM) or transmitted via USB-2 to another computing device. Image viewing can also be performed live via the USB-2 cable to a computing device or via the AV output to a compatible video monitor. Voice recordings can also be captured while recording to annotate clinical findings. In an alternative embodiment, data at a removable display device can be synchronized by docking the display device with a docking station, such as Envisionier's endoPod® docking station, and then using software, such as Envisionier's eGo Manager software, to exchange data with the docked display device. In yet another alternative embodiment involving a wirelessly connected display device, such as a tablet PC or other external computer, data can be similarly synchronized without such a docking station using similar communication software.

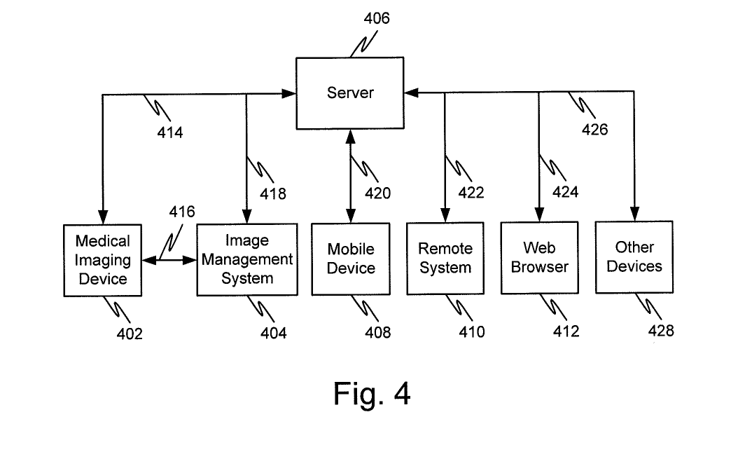

FIG. 4 illustrates one embodiment of the present invention. In this embodiment information is captured via a video capture device 402 such as an endoscopic imaging system. This information is uploaded via upload 416 to a computer 404 via a wired or wireless connection. For example, upload 416 can be USB, WiFi, Bluetooth or the like. Computer 404 can import information from a plurality of video capture devices. Similarly, computer 404 can import files such as DICOM files. (DICOM stands for Digital Imaging and Communications in Medicine standard for distributing and viewing any kind of medical image regardless of the origin.) Storage system 406 communicates with computer 404 via communicator 418. Communicator 418 can be XMPP (Extensible Messaging and Presence Protocol) or DICOM for example. In one embodiment storage system 406 is web based, is a connection and presence manager and provides video relay and buffer. The system passes on pre-recorded video streams in DICOM format and converts live video to formats that will stream on various devices. Illustrative devices depicted include an iPhone® 408, second computer 410, web browser 412 and other devices 428. Storage system 406 communicates with iPhone® via iPhone® communicator 420, iPhone® communicator can encompass for example SMS (short message service), Email, XMPP, DICOM, and H.264 (a standard for video compression). Storage system 406 communicates with second computer via second computer communicator 422, second computer communicator can encompass for example Email, XMPP, DICOM, and H.264. Storage system 406 communicates with web browser via web browser communicator 424, web browser communicator can encompass for example Email, HTTP, and FLV (flash video). iPhone® 408 can include a DICOM viewer. Second computer 410 can include a DICOM viewer and can export DICOM files to other EMR (electronic medical record) software. Web browser 412 can include a FLV viewer and can be web based.

A network of medical data communications is contemplated. In one embodiment such network is obtained by connecting a palm held endoscopic imaging system to personal computers and mobile devices. In an alternative embodiment such network further includes multiple medical devices connected to a myriad of health information transmission systems. Examples of contemplated medical devices include but are not limited to bronchoscope, laryngoscope, gastroscope and the like.

An open architecture approach is envisioned utilizing for example XMPP and DICOM standard interfaces and formats available to other vendors.

A first use scenario applies to the situation where both sender and receiver use a transmission software application. In this scenario a Data Sender is a practitioner at a first hospital or care center, who evaluates a patient. The Data Receiver is a practitioner at the same first hospital or care center, who is presently attending to other patients. At least one other practitioner is off site (“Offsite Practitioner”). The Data Sender begins an examination such as an EGD endoscopy and selects the Data Receiver and the Offsite Practitioner as recipients of the related data. Both the Data Receiver and the Offsite Practitioner are instantly notified that the examination is starting. The Data Receiver and Offsite Practitioner receive live streaming video on their data compliant devices (mobile phone, PC, tablet PC or other device) and can watch the video in progress without being present. This feature allows the Data Sender to see that the Data Receiver and the Offsite Practitioner are watching the video in transmission. Further, the Data Receiver and Offsite Practitioner can point to areas under evaluation for the Data Sender to navigate and inspect more closely.

Based upon the transmitted video, the Data Sender can request opinions from the Data Receiver and Offsite Practitioner. Further, should a recipient such as the Data Receiver and/or Offsite Practitioner have a time conflict during the examination and/or subsequent procedures the video can be saved and reviewed at a later date/time.

A second use example applies to the situation where only the sender has access to use the transmission software/application. In this situation the Data Sender can be, for example a physician in a rural setting. In use, the Data Sender practitioner performs an examination/evaluation with a data transmission compliant examination device. In one envisioned embodiment a portable endoscopic camera is data transmission compliant. The Data Sender records the video of the examination/evaluation to the device. A component of the device is connected to an office computer via a wired or wireless connection such as USB, WiFi, Bluetooth or the like. The Data Sender can then contact a Consulting Practitioner to provide a password and send a text message having a secure link to view the video. The Consulting Practitioner can view the video from any location with a Web browser. The Consulting Practitioner is also texted and emailed instructions on how to deactivate (ban) access to the video by clicking a specific link

The point of care system disclosed herein combines portable imaging with web based image and video storage in a secure, HIPAA compliant environment. In one embodiment the system comprises a camera, web services and desktop application.

In this embodiment, a hand held, portable endoscopic imaging system is disclosed that comprises a high definition camera with a universal scope coupler, a removable video display unit such as a liquid crystal display touch screen with multimedia playback, and a USB docking station used for battery charging and data transfer. An online data storage and collaborative site is further provided. In the online environment, the user can upload, store, manage, manipulate, and share exam findings such as endoscopic examinations. Using the disclosed system with its desktop companion allows data to be shared via an automated push and pull of imaging data streamlines workflow.

Features of the disclosed system can include: filing exams based on patient demographics, annotation of exams, search capabilities, report generation, editing of video, frame by frame analysis of video, and secure online sharing of endoscopic images and video.

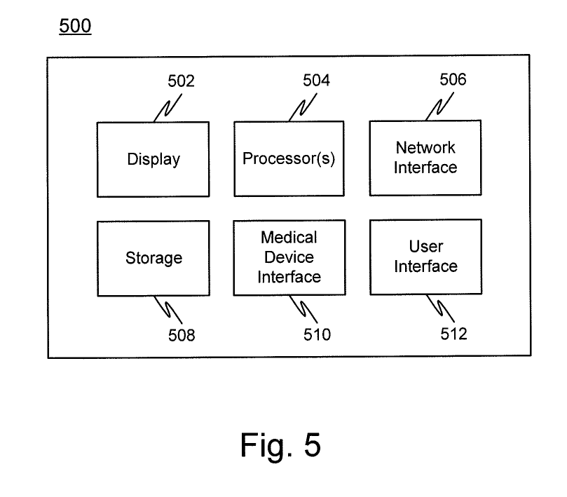

FIG. 5 is a block diagram of an exemplary unified imaging platform according to the disclosure. In particular, a unified imaging platform 500 includes a display 502, one or more processors 504, a network interface 506, a storage 508, a medical device interface 510 and a user interface 512.

In operation, digital image data from a medical imaging device is received via the medical device interface 510. The medical device interface 510 forms an interface between the unified imaging platform 500 and a medical imaging device such as an endoscope. The medical device interface can be a wired or wireless interface.

The digital image data can be processed by one or more of the processors 504 and displayed on the display 502 and/or stored in the storage 508. The processors 504 can include one or more of a microprocessor, a digital signal processor, a microcontroller, a programmable logic device, or any now known or later developed processing device suitable for use in the unified imaging platform 500. The display can include an LCD display, an LED display, a plasma display, a cathode ray tube (CRT) display, or any now known or later developed display suitable for use in the unified imaging platform 500. The storage 508 can include an electronic data storage device (e.g., SDRAM, ROM, EEPROM, Flash, or the like), a magnetic data storage device (e.g., a hard disk drive), an optical data storage device (e.g., a CD or DVD drive), or any now known or later developed data storage device suitable for use in the unified imaging platform 500 to store digital image, digital video and/or associated data.

The unified imaging platform 500 can be controlled by a user via the user interface 512, which can include one or more of a switch, a button, a position sensing device (joystick, mouse, trackball, or the like), a touch screen, a keyboard, or any now known or later developed user interface element suitable for use in the unified imaging platform 500.

The unified imaging platform 500 can communicate with external networks or systems via the network interface 506 which can include a wired or wireless network interface.

FIG. 6 is a block diagram of an exemplary endoscopic system having a rigid or flexible image collection end and a proximate image sensor. In particular, an endoscopic system 600 includes a display unit 602, an endoscope 604, a proximate image sensor 606 and a rigid or flexible optical insertion tube 608.

In operation, light is transmitted from a distal end of the insertion tube 608 to the proximate image sensor 606, which produces an analog or digital image signal. The proximate image sensor transmits the image signal to the endoscope 604 and, in turn, to the display unit 602, which can be a unified imaging platform similar to that shown in FIG. 5.

An image, generated from the image signal, can be viewed on the display unit 602. The image can also be edited, stored or transmitted to another system by the display unit 602. The display unit 602 can be removed from the endoscope 604.

FIG. 7 is a block diagram of an exemplary endoscopic system having a distal image sensor and an electrically coupled display unit. In particular, an endoscopic system 700 includes a display unit 702, an endoscope 704, an electrical link in a flexible insertion tube 706 and a distal image sensor 708.

In operation, the distal image sensor 708 produces an analog or digital image signal, which is transmitted via the electrical link 706 to the endoscope 704 and, in turn to the display unit 702, which can be a unified imaging platform similar to that shown in FIG. 5.

An image, generated from the image signal, can be viewed on the display unit 702. The image can also be edited, stored or transmitted to another system by the display unit 702. The display unit 702 can be removed from the endoscope 704.

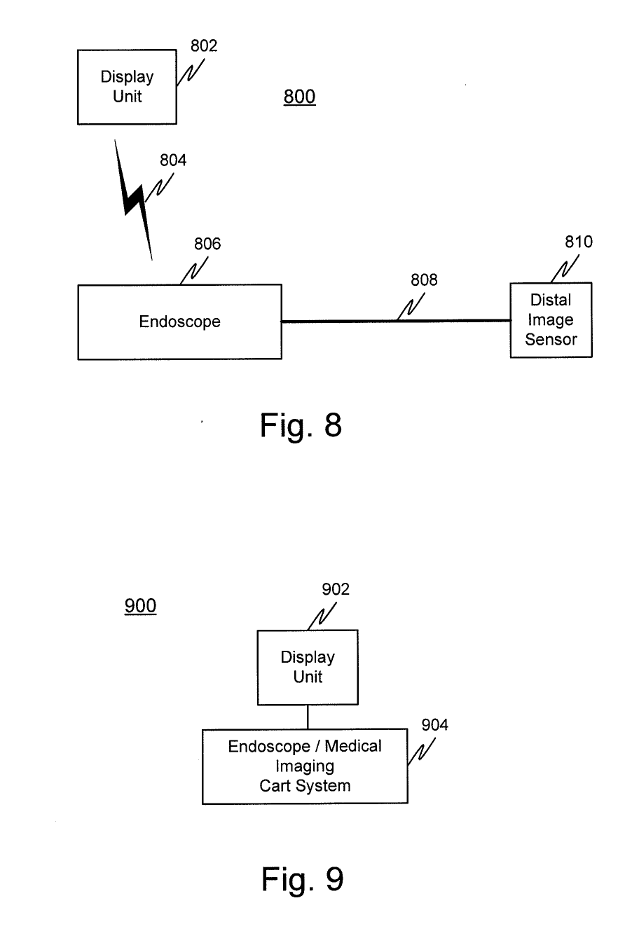

FIG. 8 is a block diagram of an exemplary system having a distal image sensor and a wirelessly coupled display unit. In particular, an endoscopic system 800 includes a display unit 802, a wireless link 804, an endoscope body 806, an electrical link in a flexible insertion tube 808 and a distal image sensor 810.

In operation, the distal image sensor 810 produces an analog or digital image signal, which is transmitted via the electrical link 808 to the endoscope body 806 and, in turn to the display unit 802 via the wireless link 804. The display unit 802 can be a unified imaging platform similar to that shown in FIG. 5.

An image, generated from the image signal, can be viewed on the display unit 802. The image can also be edited, stored or transmitted to another system by the display unit 802. The display unit 802 can be removed from the endoscope body 806.

FIG. 9 is a block diagram of a display unit coupled to an endoscopic imaging cart system. In particular a medical imaging system 900 includes a display unit 902 coupled to a medical imaging system 904. The display unit 902 can be a unified imaging platform similar to that shown in FIG. 5. An image can be viewed on the display unit 902. The image can also be edited, stored or transmitted to another system by the display unit 902.

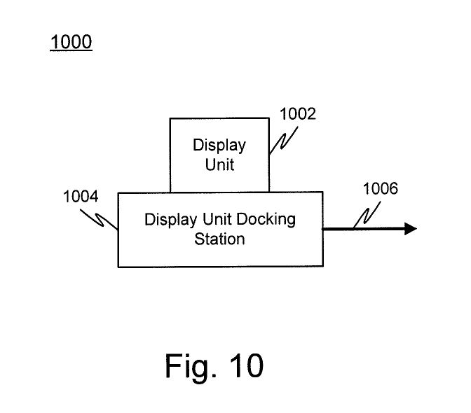

FIG. 10 is a block diagram of a display unit coupled with a docking station. In particular a medical imaging system 1000 includes a display unit 1002 coupled to a docking station 1004 that can include a link 1006 to an external system or network.

In operation, the display unit 1002 can be placed in the docking station 1004 for battery recharging and/or data transfer. Data transfer between the display unit 1002 and external systems can occur via the docking station 1004 and the link 1006.

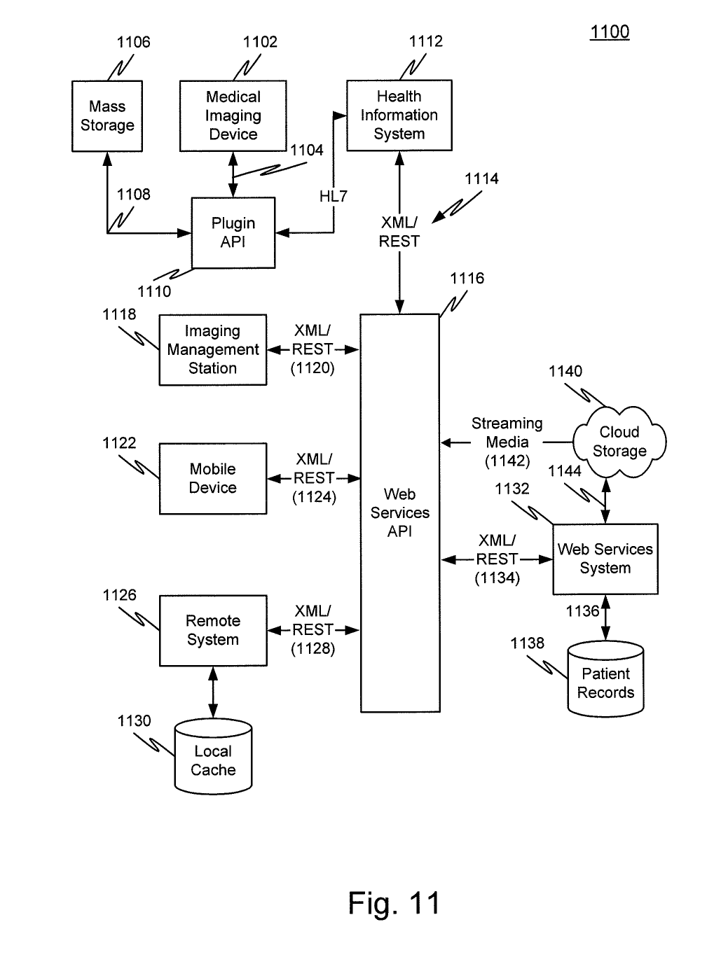

FIG. 11 illustrates software system architecture. The system 110 includes a medical imaging device 1102 (e.g., a device similar to that shown in FIGS. 6-9). The system also includes a mass storage 1106. The medical imaging device 1102 and the mass storage device are coupled to a plugin API 1110 via links 1104 and 1108, respectively. The plugin API is also coupled to a health information system 1112 via an HL7 link. The health information system 1112 is also coupled to a web services API 1116 via an interface 1114 (e.g., an XML/REST interface). The system 110 also includes an imaging management station 1118, a mobile device 1122 and a remote system 1126 respectively coupled to the web services API 1116 via XML/REST interface links 1120, 1124, 1128. A local cache storage 1130 is also coupled to the remote system 1126.

The web services API 1116 is also coupled to a web services system 1132 via an XML/REST interface link 1134. The web services system is coupled to a patient records database 1138 and a cloud storage 1140 via interfaces 1136 and 1144, respectively. The cloud storage 1140 is coupled to the web services API 1116 via a streaming media interface 1142.

As shown, the system can include a web based storage system for images and video such as endoscopic images and video. A number of web based services can be utilized via a REST style interface. All communication between clients and the web server is done over HTTPS using 256 bit AES encryption. In one embodiment, three clients are implemented: a web application, an iPhone native application, and a desktop application. The system is highly decoupled and makes use of open standards making it very flexible.

In an exemplary embodiment, the web server is composed of a pair of Amazon EC2 instances: the main server and a secondary server that acts as a database read slave and can function as a fail-over server in case the master server instance were to go down. Storage of images and video is handled for example by Amazon S3. Amazon EC2 and S3 are high performance, highly scalable and very secure. A single server is estimated to handle approximately 200-300 simultaneous users. Additional users can be supported by adding a load balancer and creating additional master-slave server instances. Hourly snapshots of server and database state are saved to Amazon EBS. Data is continuously backed up and new server instances can be brought online in minutes. A random back-up is selected each week and a complete recovery is performed on a new server instance (separate from the production server) to simulate a disaster recovery.

Access to the web services requires a software systems account, an authenticated user within that account, and authorization to perform a particular action on a particular resource by that user. Authentication and authorization are handled by the server. Each account has its own URL and its own separate database within the system. Inside of each account there may exist any number of user accounts. Users can be given coarse grained access controls. Users marked as “admin” have complete control over their account. Users not marked as admin must be assigned permission to read, create, update or delete patients, files, procedures or other users. Password protection may be provided such that three successive failed login attempt “locks” the account to prevent user access and requires administrator authorization to “unlock” the account.

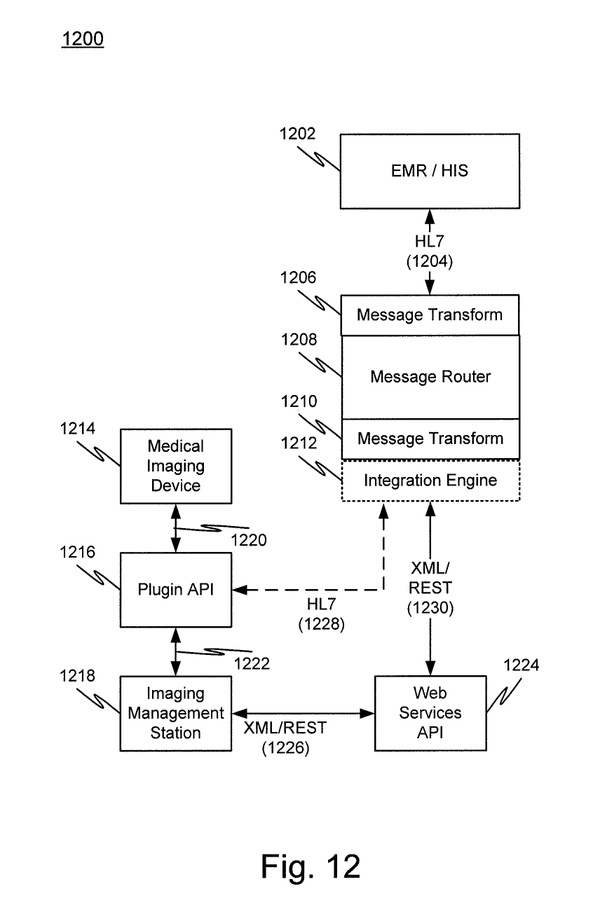

FIG. 12 illustrates integration with EMR. The system 1200 includes a medical imaging device 1214 coupled to a plugin API 1216 via link 1220. An imaging management station 1218 is coupled to the plugin API 1216 via link 1222 and coupled to a web services API 1224 via link 1226 (e.g., an XML/REST interface). The plugin API 1216 is coupled to an integration engine 1212 via an interface 1228 (e.g., HL7). The integration engine 1212 is also coupled to the web services API 1224 via an interface 1230 (e.g., an XML/REST interface). The integration engine 1212 is coupled to a message transformer 1210, which is coupled to a message router 1208 and another message transformer 1206. The message transformer 1206 is coupled to an EMR/HIS 1202 via a link 1204 (e.g., an HL7 interface).

As shown, an integration engine is used to coordinate traffic between the EMR, the web services, and the application (and by proxy, the LCD). An exemplary integration engine is MirthConnect. (http://www.mirthcorp.com/community/overview). In one embodiment a listener in implemented in Mirth that receives orders (ORM) for endoscopic procedures from AllMeds. An exemplary ORM is provided below:
MSH|̂˜\&|AllMeds∥Envisionier∥20090922161042∥ORM̂O01|165|P|2.31∥∥NE PID|1∥3187∥TEST̂TEST∥20090107|M ORC|NW∥∥∥̂̂̂20090922∥20090922161033|∥̂SmitĥJohn|∥20090922
OBR|1|36∥31276̂Nasal/Sinus Endoscopy, Surgical w/Frontal Sinus Exploration, w/wo Tissue Removal, Frontal sinus|∥∥∥∥∥∥∥∥∥∥O∥̂̂̂20090922

When the order is received by Mirth, a web service request is constructed using REST API, which then stores the order in our database. The user docks their LCD into the docking station. This will cause the Application to go through the process outlined above, additionally pulling the order ID down and storing it with the patient folder on the LCD. Alternatively, the doctor may simply enter the patient chart number on the LCD and skip this initial docking process. The doctor then proceeds to perform the examinations. When the LCD is docked again, the application copies all data from the eGo and begins uploading the image and video data. Once an image or video is uploaded, the application will look locally for the procedure ID. If not found, it will query the web service to try and find a procedure that matches the patient chart number (as entered on the LCD) and the capture date of the image. If a procedure ID is found, the application will construct an ORU message containing OBX segments that reference the image and video data. The references are pre-authenticated URLs that point to the image and video data. The ORU is sent to Mirth where it will finally be forwarded to the EMR.

An exemplary ORU is set forth below:
MSH|̂˜\&|Envisionier∥AllMeds∥20090922161026∥ORÛR01|ips2e35hhh6ak|P|2.3|∥AL∥∥∥ PID|1∥3187∥TEST̂TEST∥20090107|M
PV1|1R|∥∥̂John Smith, M.D.|̂Doe∥∥∥∥∥∥∥∥∥∥∥∥∥∥∥∥∥∥∥∥∥∥|
OBR|1|36∥31276̂Nasal/Sinus Endoscopy, Surgical w/Frontal Sinus Exploration, w/wo Tissue Removal, Frontal Sinus|∥20080401143529|∥HIST|∥Laboratory Report|200804011727∥25841̂SmitĥJohn|∥∥00809205729|∥LAB∥F∥̂̂̂̂̂AR OBX|1|TX|URL_REF|1|https:/E//E/demo.endogo.com/E/file/E/1? key=1&timestamp=1263830821&signature=NTk3ZDU5ZTE3OGM4ZTE5MGJIZmE3NGY 2N2NmN DliNjk4MzUxMDE4Zg==|″″|∥∥F|∥20081111114948∥∥∥OBX|2|TX|URL_REF|1|https:/E//E/demo.endogo.com/E/file/E/2? key=1&timestamp=1263830866&signature=N2E5ZjMwNzlhYjIxYmRjY2ExMTljNTAyZT M1ZjEwY2ZiMmENjY1Ng==|″″|∥∥F|∥20081111114948∥∥∥

This ORU will contain as many OBX segments as there were images or videos for the exam. In the case of AllMeds, the links are stored with the patient record as external documents. When the user clicks on one of the document links, the default web browser is opened pointing to the file.

An important consideration with this type of integration is that the EMR must support the ability to handle an external web link. The link is a direct link to the media data and should display in most browsers. One option is for the EMR to simply launch the default browser on the system and have it pointing at the file.

The “share” feature in the web application and the links created in the EMR integration procedure both rely on the same signing process to generate secure links to resources. When an authorized user requests a pre-authenticated link, the server generates a digital signature for that link. The pre-authenticated nature of the link means that neither the email recipient nor the EMR needs to know the credentials of the user that created the link in order to access the resource. The signature in the link is only valid for a specific resource and for a specific access method, and optionally, for a specific period of time. It is not possible for someone to simply point the link to a new resource and gain unauthorized access. It is also not possible to access the resource using an unintended method (for example, it would be unfortunate if someone could construct an HTTP DELETE request when they should have only been allowed to GET the data). An example of a pre-authenticated link is provided below:

https://demo.endogo.com/file/991?

timestamp=1267140610&signature=NDRiNGNkMmVkM2FiODJjYTgyZmVmMjg3ZmJhNWU 4MzE yN2M4NjExOA==

The server authorizes the request by computing a signature using procedure such as:

canonical_request: HTTP_method\n (GET, PUT, POST,

DELETE, HEAD, etc) timestamp\n

expiration\n (expiration is optional)
request_url
hmac: HMAC-

SHA1(canonical_request, secret_code)
signature: base64(hmac)

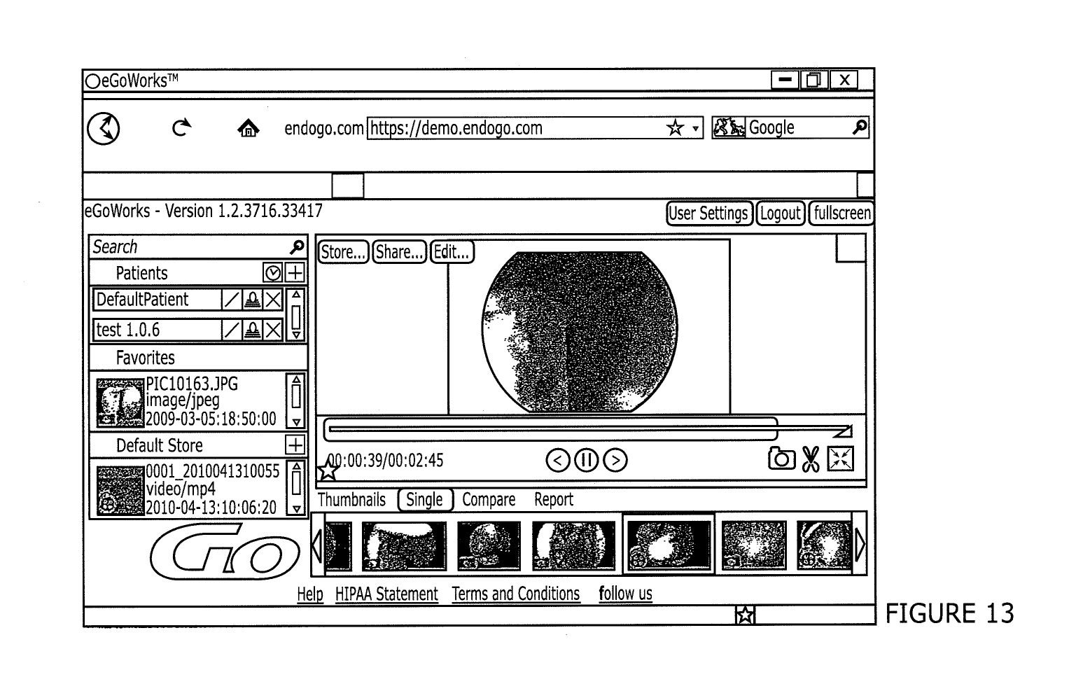

FIG. 13 provides a screen shot illustrating a web application front end. In one example the web application is built using Microsoft Silverlight 3 and runs in Firefox, Internet Explorer, and Safari web browsers on Windows and Mac OS X. It provides a user friendly front end for managing patients, images and video, editing video, sharing images and video via secure link, side by side comparison of images and video and report generation.

The application is installed on the user's computer. It runs natively on Windows and Mac OS X. Exemplary tasks include identifying docketing of LCD unit into the docking station, copy data to and from the LCD unit, and communicate with the web services and heath information systems. A Python based plugin system is contemplated as one means for the system to be extensible by end users. The application requires the user to log in and also communicates over HTTPS.

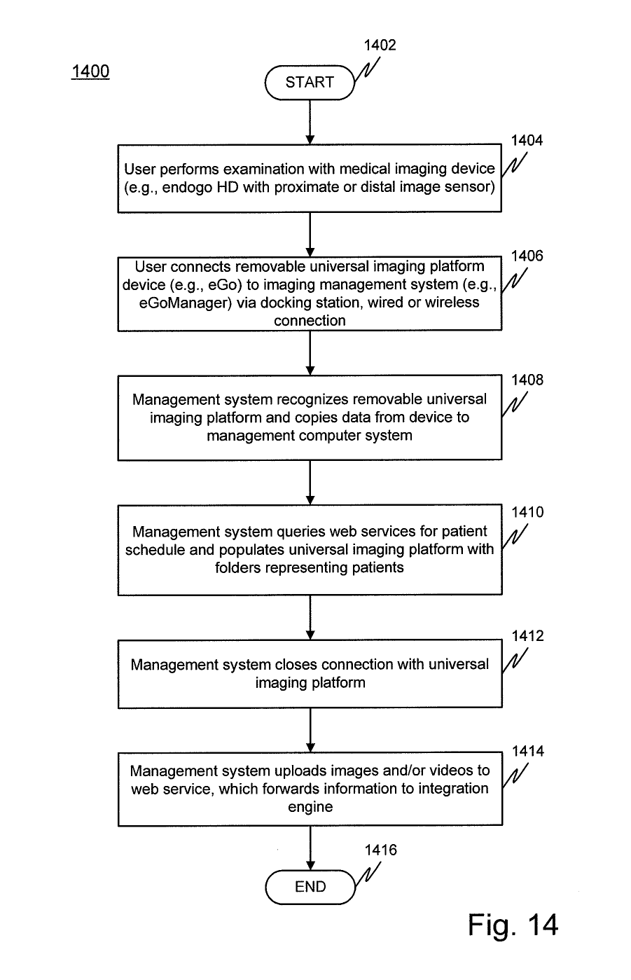

FIG. 14 shows a flowchart of an exemplary workflow within the system which includes: a user performing examination(s) 1404; user docking the LCD display unit (e.g., unified imaging platform) with a docking station 1406; application software recognizes LCD and copies all data from the LCD to the PC 1408; application queries web services for patient schedule and populates LCD with folders representing the patients (folder name is patient first initial, first 4 letters of last name) 1410; application releases the LCD 1412, LCD is now ready for additional exams. Throughout the process, the application is uploading images and videos to web service and forwarding information to integration engine 1414.

It will be appreciated that the steps shown in FIG. 14 may be repeated in whole or in part to accomplish a contemplated medical image processing task.

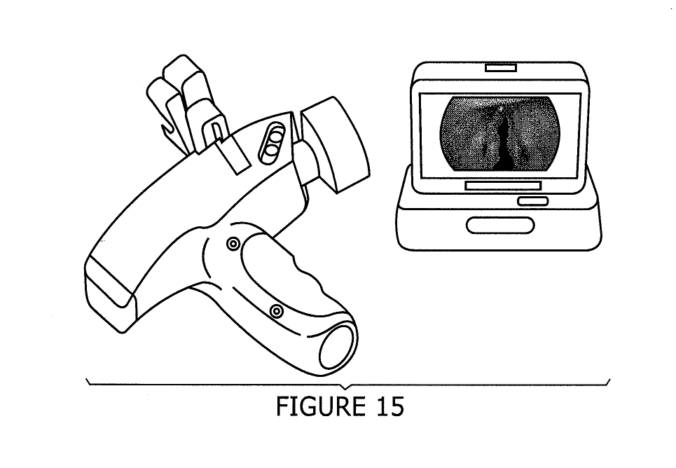

FIG. 15 provides an example of a high definition camera medical imaging system having a removable display device. This specific example comprises a camera unit, a video display unit and a docking station.

Capabilities and elements of the system disclosed herein can include for example, an on-board image processor, capability for high definition video and six megapixel photos, liquid crystal display viewing screen, touch screen for data input, on-board memory for archiving images, removable memory for transferring data to various personal computing and memory devices, high speed digital data transfer for live image viewing via a traditional monitor or on a personal computing device, and virtual Repository of endoscopic images and videos.

Related to image capture, system capabilities and elements can include for example, the ability to capture images such as endoscopic images with a hand held device, the ability to obtain high definition images and videos, a removable touch screen liquid crystal display, a sophisticated user interface, mobile multimedia play back, light source optimization technology, user specified light balances which may be optimized to work with Halogen, LED, Halide, or Xenon light sources, manual white balance, and automatic white balance.

Related to storage, system capabilities and elements can include for example, high definition images and video that can be uploaded and stored on a secure data management system, the ability to store information automatically in a secure HL7 format, the ability to easily store and transfer electronic medical records, the ability to extract a still image from a video, trim the video, capability for one touch download, and side by side comparison of videos, photos, and CT images.

Related to sharing of data, system capabilities and elements can include for example, ability for practitioners to share images/exams at the point of care with the removable liquid crystal display monitor, dual image comparison allowing practitioners to demonstrate patient's normal and abnormal pathology, ability to automatically upload data to streamline workflows by eliminating redundant capture, tag, record, export, and import tasks normally associated with moving data such as endoscopic data; and a web based storage solution that sends a secure link to email allowing practitioners to reach and or send data anytime, anywhere without restrictions of video file size.

For exemplary purposes only, a camera unit weighs about 410 grams, is about 6.5″ long, 7.5″ tall without LCD, 10″ tall with LCD, provides 1280×720 resolution HD video (MPEG4 compression, AVI format), provides five mega pixel still image (JPEG format), and comprises a CMOS image sensor, universal C-mount endoscope coupler, HDMI digital video output, Composite analog video output, removable, rechargeable lithium-ion battery, hot keys for still/video capture and zoom in/out, and a rugged, powder-coated magnesium shell.

For exemplary purposes only the video display unit weighs about 100 grams, is about 3.75×″3.25″×1.125″, and comprises a 3.5″ touch screen (as measured on the diagonal), an removable SD card, a multimedia playback, a non-removable, and a rechargeable lithium-ion battery.

For exemplary purposes only the docking station is 4.5″×2.25″×4.5″and comprises a 50 pin port for the LCD unit, charging ports for lithium-ion batteries, wall power port (DC 5V at 3A), and USB 2.0 mini port. The docking station in one embodiment implements mass storage driver for data transfer (USBSTOR on Windows).

Administrative, physical and technical safeguards consistent with HIPAA Security Standards are envisioned to protect the confidentiality, integrity and availability of data. These safeguards include housing servers in physically secure, geographically disperse data centers, protecting servers with firewalls, securing remote connections to servers via encryption means such as 256 bit AES encryption, providing each user with a unique id and password which is required to access the system, maintaining system backups, providing redundant systems for fail-over, and logging all access attempts and system activity. System design features related to HIPAA compliance include file names are anonym zed and stored separately from patient data, minimal patient data is stored in web database relying instead on EMRs and other HIT systems to store more comprehensive demographics.

The server then compares the computed signature with the signature in the query string. If any part of the request is different from the original, the signatures will not match and so the request is denied. The secret code is unique for each account and known only to the server.

The optional expiration parameter allows the sender to deny access to the resource after a specific period of time. This does not prevent the receiver from downloading the resource before that expiration period and obtaining a local copy, however this is not the intended purpose of the expiration parameter. It is assumed that the receiver is a trusted party and that there is no issue with their obtaining a local copy of the resource. However, when sending a link to an external party, certain security aspects can be out of the control of the sender. The link may be stored on an unsecured machine in plain-text, the link may be sent or received over an unsecured channel, the link may be inadvertently sent to the wrong party. The expiration parameter provides a mechanism to limit the amount of time a particular resource is vulnerable to these types of unintended exposures in the wild. Links stored in the EMR do not typically have an expiration parameter since the communication channels between the application, Mirth and the EMR are assumed to be secure. Also, the links within the EMR are assumed to be protected by the EMRs own security systems.

An important aspect of the pre-authenticated links is that they contain no identifying patient information. However, there is no mechanism in the system to determine whether or not there is patient information embedded in the file that the link points to. For example, the patient's name may be spoken in the audio track of a video, or their name and date of birth may be embedded in a CT image. In all cases, it is the responsibility of the user to redact any potentially sensitive information before a file or link to a file is transmitted to another party.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention. For example, it is also anticipated that the viewing screen on the camera may be a commercially available twin LCD display having a backlight and a system LSI (large-scale integrated circuit) chip between two LCD screens, allowing both sides of the display to work at the same time. Further, the system may include an audio input for accommodating stroboscopic analysis.

The system described herein is a flexible, secure system designed to optimize workflow. The workflow and integration scenarios outlined in this paper only represent exemplary possible scenarios. Envisioned scenarios include a Javascript and HTML that will require no browser plugins, a USB interface to supersede the present Mass Storage driver, and the use of DICOM wrappers to integrate with PACS.

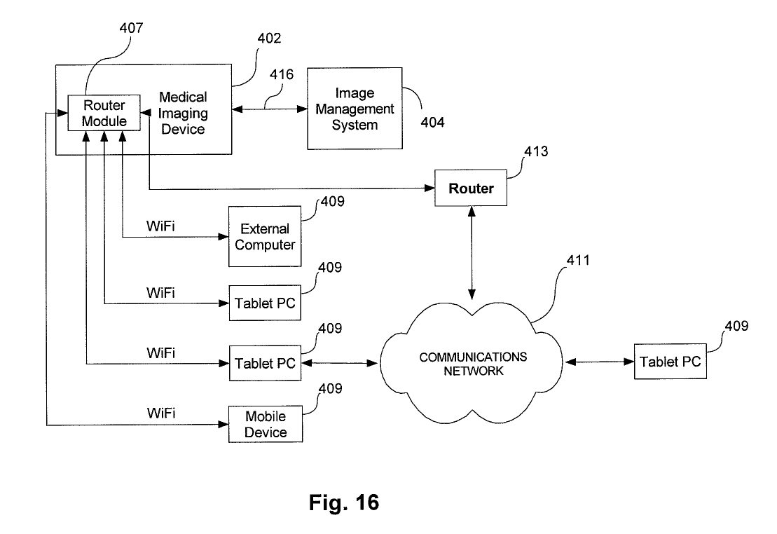

FIG. 16 shows an alternative embodiment of a medical imaging system. In this embodiment, the medical imaging device 402 is specially-configured to communicate directly with one or more conventional, commercially-available external computers 409 via a communications network. In such an embodiment, the external computer 409 acts to display the captured images, and thus the medical imaging device 402 may omit an attached or attachable display unit, such as video display unit 36 shown in FIG. 3. Examples of such external computers include a PC, a desktop computer, a smartphone such as the Apple® iPhone®, or a tablet PC such as the Apple® iPad® or an Android or Linux OS-based tablet PC. Various commercially-available external computers may be used, provided that the external computer is capable of performing network communications of the type generally used in the Internet and Web contexts.

In such an embodiment, the medical imaging device 402 includes a router module 407 in communication with the imaging components (such as an image sensor) of the medical imaging device 402. In one embodiment, the router module 407 is provided internally to or otherwise integrally with the medical imaging device 402, e.g., by including appropriate hardware and/or software as components of the medical imaging device 402. In an alternative embodiment, the router module 407 is provided as a physically distinct component, such as a dongle, that is connectable to an appropriate communications port, such as a composite video output or RCA jack, of the medical imaging device 402.

The router module 407 is configured to receive image data signals corresponding to the still and/or video images captured by the medical imaging device and to transmit corresponding image data signals to the external computers 409, such that captured images can be viewed at the external computers 409.

In one such embodiment, uncompressed raw image data is transmitted from the router module 407 to the external computer(s) 409, and image processing functions are performed upon such raw image data at the external computer(s) 409.

In an alternative embodiment, the medical imaging device 402 processes the received images and then prepares for transmission of image data in a predetermined manner, e.g., at a rate of 30 frames per second, with a lag rate of less than 0.01 seconds, and in VGA or QVGA format, and then the router module 407 transmits processed image data to the external computer(s) 409. By way of example, the processing performed at the medical imaging system may include the steps of encoding, compressing and/or otherwise rendering image data.

The router module 407 uses its router functionality to transmit the prepared image data in a prescribed manner. Preferably, the router module 407 performs such transmission to at least one network address using conventional transmission protocols characteristic of Internet and web-based communication. As will be appreciated by those skilled in the art, the external computer 409 receives the transmitted image data by way of the network address. By way of example, suitable router functionality may be implemented using a commercially-available “Linux-on-a-stick” system, such as those manufactured and/or sold by Gumstix, Inc. of San Jose, Calif. By using such conventional transmission protocols, this aspect of the present invention may take advantage of the common communication, computational and image-processing capabilities of conventional external computers, such as web-enabled tablet PCs, which are already well-equipped with suitable hardware and software for receiving images transmitted via such networks using such transmission protocols.

Advantageously, the use of such conventional transmission protocols inherently allow for use of encryption in transmitting the image data to the external computers in a secure fashion. Further, conventional security measures of such devices, such as the requirement for a username and/or password to access or “unlock” the external computer 409 can be used to provide additional security. These security measures help to prevent interception and/or viewing of private patient data by unauthorized individuals and/or computing devices. Such security measures facilitate use of the system to transmit patient and other images in the medical context in which secure transmission is often required to comply with HIPAA or other patient-privacy laws or regulations.

In one mode, the router module 407 transmits wirelessly to a local (e.g., within approximately 10 meters) external computer 409, e.g., via a micronetwork created by the router module 407. For example, this transmission may be performed via a WiFi connection with a local tablet PC, after the tablet PC and router module 407 have “paired.” In such an embodiment, image data may be transmitted using WEP encryption, to provide the security functionality referenced above. In this mode, the router module 407 connects directly the external computer 409.

In a preferred embodiment, the transmission from the router module 407 is performed to multiple IP addresses, e.g., using IP multicast technology. By way of example, such multicasting may be used to concurrently transmit captured images to multiple external computers 409 within the range of the wireless network established by the router module 407—e.g., within a single operating room. Preferably, such transmissions are made using the UDP transmission protocol. Use of UDP reduces or eliminates certain transmission delays association with error correction functionality inherent to transmissions using the TCP/IP protocol, including delays associated with TCP/IP packet acknowledgements.

In another mode, one of the external computers, such as a tablet PC 409, further transmits wirelessly to a remote (or local) external computer 409 using a broader wireless communications network technology, such as a broadband wireless telephone network, which is shown for illustrative purposes as communications network 411 in FIG. 16. By way of example, a 4G/LTE wireless telephone network is a suitable communications network for this purpose. Accordingly, images can be transmitted among multiple external computers in a videotelephony/video chat format functionally similar to Apple® Facetime or Skype® videotelephony applications. By way of example, this allows the captured images to be viewed by remotely located physicians, specialists, etc. over a much broader geographic territory.

In yet another mode, the router module 407 communicates via WiFi or other local wireless connection to another router 413, such as a conventional wireless router, which may in turn be connected to a communications network 411, such as the Internet. As will be appreciated by those skilled in the art, in this mode, the router module 407 may communicate with other Internet-connected external computers 409 via the communications network 411.

Further, in a preferred embodiment, the router module 407 is configured with software and/or hardware allowing for bi-directional communication, e.g., in a full duplex channel, between the medical imaging device 402 and the external computers 409. In such a bi-directional embodiment, it is possible not only to transmit images from the imaging components of the medical imaging system 402 to the external computer 409, but also to transmit control signals from the external computer 409 to the medical imaging system. In such an embodiment, the external computer 409 may store and execute a special-purpose software application providing a graphical user interface for providing and/or communicating such input. By way of example, the software application may allow a user to provide input at the external computer 409 that is transmitted to the medical imaging device 402 to cause the medical imaging device's imaging components (such as its image sensor) to adjust image setting parameters such as white balance, exposure, hue, and lighting variables.

An optional special-purpose software application for the external computer 409 may be used to provide additional functionality. By way of example such a software application may be used not only to display the image data, but also to associate and/or save the image data in association with a particular patient. Similarly, the software application may provide an interface permitting voice-activated control of system functions and/or making of audio or video recordings and storing/associating them with a particular patient. By way of example, such recordings may be used to record a physician's or other reviewer's notes and comments, e.g., for forwarding to a medical transcription service. The software may also be used to synchronize the image or other data with a data repository, such as Envisionier's eGoWorks software or another cloud-based data repository, a Personal Health Record (PHR) system, an Electronic Health Record (EHR) system, or a Picture Archiving and Communication System (PACS). Advantageously, such a configuration may connect captured data directly to the data repository without intermediary computing systems and the need for integration with such systems may thus be eliminated or substantially avoided.

Having now described a few embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention and any equivalent thereto. It can be appreciated that variations to the present invention would be readily apparent to those skilled in the art, and the present invention is intended to include those alternatives. Further, since numerous modifications will readily occur to those skilled in the art, it is not desired to limit the invention to the exact construction and operation illustrated and described, and accordingly, all suitable modifications and equivalents may be resorted to, falling within the scope of the invention.

What is claimed is:

1. An endoscope comprising:
a main body portion having a proximal end and a distal end;
a flexible insertion tube coupled to the main body portion and having a proximal end and a distal end;
a video display unit removably coupled to the main body portion via an electromechanical coupling;
an image sensor unit disposed at the distal end of the flexible insertion tube;
an electrical link electrically coupling the image sensor unit to the main body portion, the electrical link extending from the image sensor unit through the flexible insertion tube;
a user interface; and
an image processor coupled to the electrical link, the user interface and the video display unit.

2. The endoscope of claim 1, wherein the user interface and the image processor are disposed in the main body portion.

3. The endoscope of claim 1, wherein the user interface and the image processor are disposed in the video display unit.

4. The endoscope of claim 1, wherein the image sensor unit is at least one of a charge coupled device or a complementary metal-oxide semi-conductor.

5. The endoscope of claim 1, wherein the video display unit is a liquid crystal device.

6. The endoscope of claim 1, wherein the user interface is disposed on the video display unit.

7. The endoscope of claim 1, wherein the main body portion provides a two-axis rotatable component for coupling to the video display unit to allow the video display unit to rotate about the longitudinal axis of the main body portion and to rotate about a vertical axis extending through the video display unit.

8. The endoscope of claim 1, wherein the image processor and related components includes memory having a software program to provide control of image information received from the distal image sensor unit, information from the user interface, and the video display unit.

9. An endoscope comprising:
a main body portion having a proximal end and a distal end;
a flexible insertion tube having a proximal end and a distal end;
an image sensor unit is located at the distal end of the flexible insertion tube;
an electrical link extending from the image sensor unit through the flexible insertion tube to an interface section in the main body portion;
a unified imaging platform including:
a video display unit adapted to be removably coupled mechanically to the main body portion and coupled to the main body portion via a wireless link;
a user interface; and
an image processing, display and storage section coupled to the user interface and the video display unit, whereby the video display unit, user interface, and image processor may be removed mechanically from the main body portion while maintaining a data link between the unified imaging platform and the main body portion via the wireless link.

10. The endoscope of claim 9, wherein said image sensor unit is a complementary metal-oxide semi-conductor sensor

11. The endoscope of claim 9, wherein the video display unit is a liquid crystal display device.

12. The endoscope of claim 9, wherein the main body portion provides a two-axis rotatable component for coupling to the video display unit to allow the video display unit to rotate about the longitudinal axis of the main body portion and to rotate about a vertical axis extending through the video display unit.

13. The endoscope of claim 9, wherein the unified imaging platform includes a computer-readable memory having a software program stored therein, that when executed by a processor in the unified imaging platform, causes the unified imaging platform to provide control of image information received from the distal image sensor unit, information from the user interface, and information sent to the video display unit.

14. The endoscope of claim 9, wherein the image processor adaptor includes the user interface and is coupled to the video display unit via an external cord.

15. A unified imaging platform comprising:
a processor adapted to process image data received from a image sensor disposed in a distal end of an endoscope insertion tube;
a display device coupled to the processor and adapted to display image data;
a storage device coupled to the processor and adapted to store image data;
a network interface coupled to the processor and adapted to communicate data between the processor and a system outside the unified imaging platform; and
a medical device interface adapted to wirelessly receive data from a transmitter disposed in a medical imaging device.

16. A medical imaging device comprising:
a distal image sensor coupled to an electrical link disposed in an insertion tube, the distal image sensor being disposed at a distal end of the insertion tube;
a main body interface coupled to a proximate end of the electrical link and being disposed in a main body portion of the medical imaging device, the main body interface being adapted to wirelessly transmit data received via the electrical link; and
a display unit including a wireless data receiver adapted to receive the data transmitted by the main body interface.

17. A system for processing medical image data, the system comprising:
a medical image processing unit having a processor, a storage, a display unit and an interface;
a web services system providing a web service interface, the web services system including one or more processors, a first storage and a second storage,
the web services platform being adapted to provide an interface for receiving medical image data and patient information from the medical image processing unit and to store the medical image data in the first storage and the patient information in the second storage,
the web services platform further adapted to provide the medical imaging data to another system via the web service interface.

18. The system of claim 17, wherein the web services system is further adapted to provide an interface to a health information system for transferring data between the health information system and the medical image processing unit via the web services system.

19. A computer readable medium having stored thereon software program instructions that, when executed by a computer, cause the computer to perform operations comprising:
receiving medical image data from a medical imaging device;
storing the medical image data;
displaying the medical image data on a display device coupled to the computer;
transferring the medical image data to another system via a web services interface; and
receiving an order for an examination from the other system via the web services interface.

20. A computer readable medium having stored thereon software program instructions that, when executed by a processor in a handheld wireless device, cause the processor to perform operations comprising:
receiving medical image data from an external system via a web services interface, the medical image data being generated by a medical imaging device;
storing the medical image data; and
displaying the medical image data on a display device coupled to the handheld wireless device.

21. The computer-readable medium of claim 20, wherein the operations further comprise:
receiving the medical image data in real time from the medical imaging device via the web services interface.

22. The computer-readable medium of claim 20, wherein the operations further comprise:
notifying the medical imaging device in real time that the handheld wireless device is receiving the medical image data via the web services interface.

23. The computer-readable medium of claim 20, wherein the operations further comprise:
transmitting data from the handheld wireless device to the medical imaging device in real time via the web services interface as an examination is being performed using the medical imaging device.

24. A medical imaging system comprising:
an endoscope comprising:
a main body portion having a proximal end and a distal end;
an insertion tube coupled to the main body portion and having a proximal end and a distal end;
an image sensor unit disposed along the insertion tube;
an electrical link electrically coupling the image sensor unit to the main body portion; and
a router module in communication with the image sensor unit, the router module being configured to transmit via wireless transmission image data corresponding to images captured by the image sensor unit; and
an external computer comprising:
a transceiver for receiving image data transmitted from the router module via wireless transmission;
a memory for storing received image data; and
a display device for displaying images captured by the image sensor unit.

25. The medical imaging system of claim 24, wherein the endoscope further comprises an image processor coupled to at least one of the electrical link and the router module, and wherein the router module is configured to transmit image data processed by the image processor.

26. The medical imaging system of claim 24, wherein the router module transmits raw image data to the external computer, and wherein the external computer further comprises an image processor, and the external computer's display device is configured to display image data processed by the image processor.

27. The medical imaging system of claim 24, wherein the router module is configured to transmit data to the external computer via a WiFi connection.

28. The medical imaging system of claim 24, wherein the router module is configured to transmit data to the external computer using data encryption.

29. The medical imaging system of claim 24, wherein the router module is configured to enable bi-directional communication with the external computer.

30. The medical imaging system of claim 29, wherein the external computer stores in its memory a software application providing a graphical user interface for receiving user input, and wherein the software application is configured to transmit image sensor control parameters corresponding to the user input to the router module of the endoscope.

31. The medical imaging system of claim 24, wherein the external computer comprises a tablet PC.

32. The medical imaging system of claim 24, wherein the router module is integrated into a housing of the endoscope.

33. The medical imaging system of claim 24, wherein the router module is a body distinct from, but operably connectable with, the endoscope.

34. The medical imaging system of claim 24, wherein the transceiver is configured for receiving data transmitted via WiFi wireless transmission from the router module.

35. The medical imaging system of claim 24, wherein the external computer is further configured to transmit image data to another external computer via a wireless telephone network.
